(19) United States
(12) Patent Application Publication
(10) Pub. No.: US 2007/0135079 A1
(43) Pub. Date: Jun. 14, 2007

(54) Sample-correlated bit-level synchronization

(76) Inventor: Steven D. Bromley, Austin, TX (US)

Correspondence Address: MOTOROLA, INC., 1303 EAST ALGONQUIN ROAD, IL01/3RD, SCHAUMBURG, IL, 60196, US

(21) Appl. No.: 11/301,150

(22) Filed: Dec. 12, 2005

(51) Int. Cl. H04B 1/16

(52) U.S. Cl. 455/343.1

(57) ABSTRACT

A data receiver is activated at periodic intervals to receive data transmitted by any one of a plurality of transmitters having non-overlapping times of transmission. The receiver output is processed to determine the presence of a modulation type and to achieve bit and frame synchronization. One or more messages are received and the data receiver subsequently placed in a de-activated mode for reducing power consumption until the next activation.

### TECHNICAL FIELD OF THE INVENTION

The present application may relate to radio communications systems and more particularly to systems and methods for establishing communications.

### BACKGROUND OF THE INVENTION

In mobile communications the receiver requires a power source, and it may be desirable to minimize the power consumption. An example is a system having base stations communicating with mobile terminals (MT) in vehicles. Briefly, such a system accepts inputs from a system computer indicating that specific data is to be sent to a vehicle. The system then communicates the data to the vehicle to complete the transaction. The system is intended to cover a wide geographic area, and a number of fixed transmitters are deployed at geographic locations which are suitable to provide communications in the area. Each transmitter is termed a Base station computer (BSC) and is assigned a particular time slot for transmission, such that all of the BSC in a geographical area occupy different time slots, so as to avoid co-channel interference.

When a MT receives data from a BSC, the MT takes the appropriate action locally within the vehicle.

A signal protocol for such a system may comprise radio frequency data transmissions grouped into packets, each packet having a general structure given by:

/--QUIET CARRIER--/--PREAMBLE--/--FLAG PATTERN--/--MESSAGE FRAME#1--/--MESSAGE FRAME#2--/--MESSAGE FRAME#N/--TRAILER--/

where the bit transmission order is from left to right.

The QUIET CARRIER has no modulation imposed thereon and may be used to detect the presence or absence of a received signal at the mobile unit, but does not aid in synchronization of the clocks between the base station and the mobile unit. The PREAMBLE is used to permit the determination of whether an appropriate modulation type is being used, and to synchronize timing of the subsequent signal processing at the bit level. The FLAG PATTERN indicates that the PREAMBLE has completed and that one or more MESSAGE FRAMEs will follow. A TRAILER may be provided. The number of bits in each of the portions of the packet may vary with the application.

FIG. 1 shows a BSC packet, including the time duration of each of the major elements of packet and the number of bits in each of the elements of a packet in an example system, and may be considered as representative of other systems. Digital data is transmitted using a minimum shift keying (MSK) modulation scheme having signaling frequencies of approximately 1200 Hz and approximately 1800 Hz and at a speed of approximately 1200 bits per second. A logical “0” (space) is 1.5 cycles of the 1800 Hz signal and a logical “1” is one cycle of the 1200 Hz signal.

Each BSC may transmit a sequence of MESSAGE FRAMEs in a packet during the assigned time slot, with the maximum number of MESSAGE FRAMEs dependent on the particular system. The BSC transmitter then does not emit electromagnetic energy on the system frequency until the next scheduled time slot for the specific BSC. The maximum time that a BSC transmitter will be active is approximately 1 second, and transmitters are assigned slots that are of 8 second duration. Generally 8 transmitters can be grouped together for time synchronization purposes such that each BSC is assigned a different 8 second slot. As the MT unit may be in range of only one of the BSC, the time between packet transmissions which are addressed to a specific mobile unit and which may be received by that unit may be as long as 64 seconds. Moreover, due to message traffic demands, it may not be possible or desirable to transmit the message to a specific mobile unit during every BSC time allocation. For circumstances where there is overlapping coverage for transmission between multiple BSC and a MT, the receiver in the MT may receive the same message from more than one BSC.

The MESSAGE may have a data structure appropriate to the usage. After the first data frame, the remaining data frames in a time slot follow in succession. The frames may be separated by a shortened version of a PREAMBLE and a FLAG PATTERN.

As the MESSAGE intended for a MT may occur infrequently, the power being consumed by the receiver and other electronics during times when desired information is not being transmitted by the system may result in premature exhaustion of battery capacity if the receiver is operated continuously.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates the message structure transmitted from a Base Station Computer (BSC) in a communication system;

FIG. 2 illustrates a deployment of a BSC and a mobile unit, the mobile unit having a receiver and a signal processor;

FIG. 3 illustrates a first example of the relationship of signal processor/receiver activation time to that of a message transmitted from a BSC;

FIG. 4 illustrates a second example of the relationship of the signal processor/receiver activation time to that of a message transmitted from a BSC;

FIG. 5 illustrates a method of receiving data from a BSC; and

FIG. 6 illustrates details of step 520 of FIG. 5, for performing bit and frame synchronization.

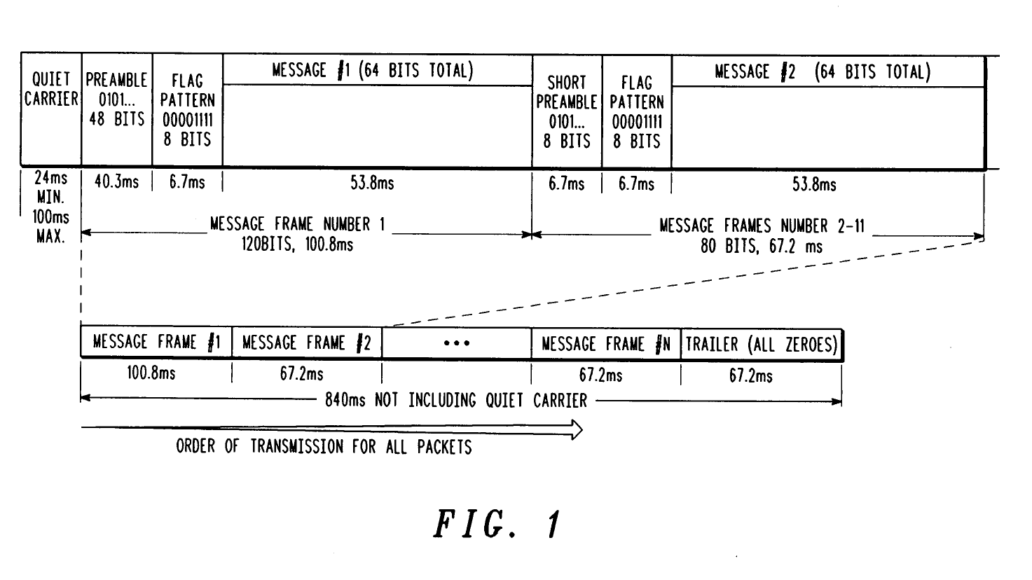

### DETAILED DESCRIPTION OF THE INVENTION

Exemplary embodiments may be better understood with reference to the drawings, but these examples are not intended to be of a limiting nature. Like numbered elements in the same or different drawings perform equivalent functions.

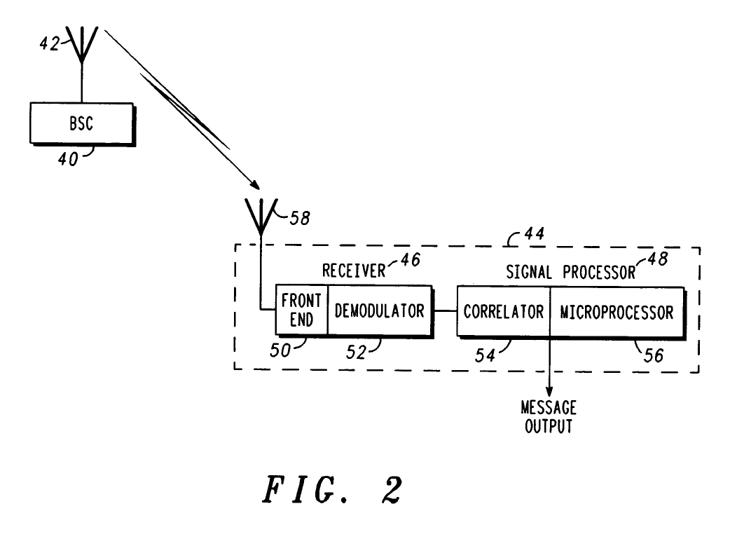

In an example, illustrated in FIG. 2, a radio communications system includes a “Base Station Computer” (BSC) 40 at a geographical location for transmitting a digital message on a carrier wave, a transmitting antenna 42, and a mobile unit 44 or data receiver having an a receiver 46 and a signal processor 48, and an antenna 58. The term BSC is understood to mean both a computing device with associated memory and peripheral devices including communications interfaces as well as a modulator and amplifier forming a radio transmitter for connection to the transmitting antenna 42. The receiver 46 includes a front end 50 and a demodulator 52, the demodulator providing an output which is input to the signal processor 48. The signal processor 48 may include a cross-correlator 54 and a microprocessor 56.

The demodulator 52 and the cross-correlator 54 are functional elements and may be located either in the receiver 46 or in the signal processor 48, or in a separate functional unit and may be implemented either as analog or digital circuits, or a combination of the two types of circuits. The microprocessor 56 may include an arithmetical/logical unit (ALU), random access memory (RAM), non-volatile memory or battery backed-up memory, and input-output circuits, as is known to persons skilled in the art, for executing stored software code to perform the functions described herein. The terms “signal processor” and “microprocessor” are generally used interchangeably, and the microprocessor may include the cross-correlator and the demodulator functions. In the example of FIG. 2, the cross-correlator function is allocated to the signal processor 48, and the demodulator 52 is allocated to the receiver 46, however this is not intended to suggest a limitation on the locations thereof within the mobile unit 44. Further, it will be apparent to a person skilled in the art that at some location within the receiver 46 or the signal processor 48, the received radio signal is converted from an analog form to a digital representation thereof.

The power consumption of a radio receiver may be reduced by turning the receiver off when the receiver is not receiving or processing data. Absent an accurate clock in the receiver, the receiver may be turned on at periodic intervals to determine whether a message is being addressed to the mobile unit. An “accurate” clock means that a clock frequency in the mobile unit bears a known relationship to a clock frequency in the BSC, such that a time base may be established at BSC and the mobile unit such that activities may be conducted in synchronism, and that this state is maintained for a period sufficient for system operation in accordance with the system design.

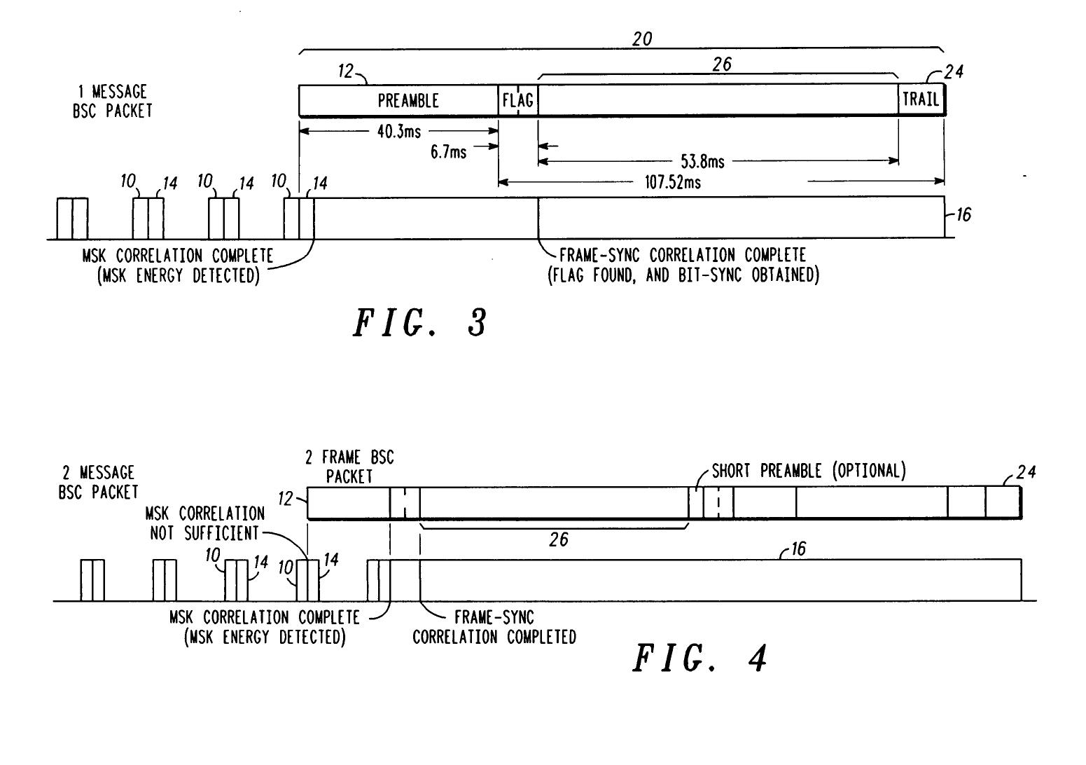

In an example, a receiver 46 and signal processor 48 may be turned on periodically, and the radio signal received by the antenna 58 may be processed by known techniques for estimating the signal spectrum, such as evaluating the zero crossings of the demodulated audio signal, or cross-correlating the demodulated signal with a bit pattern known to have been transmitted. Referring to FIG. 3 and FIG. 4, the sampling and evaluation process is performed sufficiently often that the PREAMBLE 12 portion of the MESSAGE, having a 40 ms duration, will be sampled. The time between activations of the receiver 46 may be, for example, 35 ms, in which circumstance the first occurrence of a PREAMBLE 12 may be detected.

The effect of periodic activation of the receiver 46 on overall power consumption may be estimated by considering that a signal processor 48 and receiver 46 may take about 5 ms to activate, and the receiver and signal processor 48 may take another 5 ms to collect the data required for determination that a signal is present. This process consumes a total about 10 ms of the overall period between activations. Considering the situation where the activation and data collection are sequential, the receiver requires full power for ( 10/35) or 28 percent of the time. All or a portion of the processor 48 may be disabled as well. As the power in the non-activated state is considerably smaller than in the activated state, the power consumption is reduced approximately 28 percent of that which would have been consumed in a situation where the receiver 46 and the signal processor 48 are operating continually, and the periodic activation may result in a considerable increase in battery life. A small amount of power is required to maintain the timing circuitry for initiating activation, which may be either a part of the signal processor 48 which is not shut off during the deactivation periods, or a separate circuit. Maintenance of a time base by use of a clock oscillator and digital circuitry is well known in the art, and the time may be measured in elapsed time from an event, or synchronized with a conventional reference such as Global Positioning System (GPS) time, or the like. Various activation strategies may be used, depending on the duty factor desired and the probability of receiving a desired message. The strategy of the present example results in a high probability of determination that a signal is present, providing that the PREAMBLE 12 is present for a sufficient period during the receiver 46 data collection period 14.

FIG. 3 illustrates an example of the relationship of signal processor 48/receiver 46 activation period 10, and data collection period 14 to the transmission of packets 20 from a BSC, where there is an arbitrary offset in the time base between the BSC and the mobile unit 44. Comparison of the time bases may take place at the output of the receiver 46, and the received signal at the demodulated output is presumed to be the basis for the examples presented herein, although other time reference locations may be used.

A time-base offset may arise when the mobile unit 44 has not received a signal for an extended time period, such as when the mobile unit 44 is in a vehicle which has been parked in an underground garage. Periodically, in this example at 35 ms intervals, the signal processor 48 and receiver 46 are activated, and a 5 ms data sample 14 of the receiver output collected and processed. Where there is a determination of no signal present, the signal processor 48 and receiver 46 are deactivated, and the sequence repeated periodically.

The data collected by the signal processor 48 during the 5 ms data collection period 14 is analyzed to determine the presence of a MSK signal having the desired bit pattern, and should the signal be determined to be present, the signal processor 48 software program may align the detection filters to the appropriate time for the presence of either a mark or a space to achieve the highest signal to-noise ratio and inter-symbol discrimination. This process may be termed bit synchronization. The detection or demodulation filters may be circuitry associated with the receiver 46 or, alternatively, performed as calculations in the signal processor 48. For convenience, this discussion has the demodulation filters 52 located in the receiver 46, but this is not intended as a limitation.

Signal presence may be based on a spectral estimation process or a cross-correlation. In a cross-correlation process, a known bit pattern stored or generated in the mobile unit 44 is compared with the received data, either prior to or subsequent to demodulation, and a determination of the relative correlation between the known bit pattern and the received data is performed. The received data may be in analog form, in a digital representation of the analog signal, or in a discrete representation of mark and space values.

In the example illustrated in FIG. 3, the received data in the PREAMBLE 12 is a repeating pattern of logical “1” and logical “0” bits, 01010101 . . . , and the known bit pattern used by the mobile unit 44 for correlation is the same pattern. The resultant cross-correlation coefficient, or a similar measure, may be used to determine signal presence. Alternatively another means of determining signal presence may be used prior to identifying the presence of the PREAMBLE 12. Providing that the cross-correlation coefficient exceeds a pre-determined threshold, the PREAMBLE 12 is considered to be present. The cross-correlation coefficient threshold is a measure of the received signal-to-noise ratio, and a suitable value is chosen based on a desired probability of false detection and probability of detection.

For the example given, where the known pattern is periodic over a two-bit span, the number of lags in the cross-correlation process may be limited to correspond the time interval of the periodicity. As more than one data sample may be taken during a single bit time duration, and the lag at which the maximum correlation coefficient is found represents the relative offset between the receiver clock and the transmitter clock, in terms of alignment of the receiver demodulator 52 output bit stream with the signal processor 48 time base. When the PREAMBLE 12 has been identified, the receiver 46 remains in an active state, in the expectation that the remainder of the transmitted packets 22 will follow sequentially.

While a simple pattern of alternating “0” and “1” values has been described in this example, other patterns may be used, providing the data receiver and the transmitter use the same pattern for the PREAMBLE 12. Patterns such as maximal-length codes may also be used.

With the time clocks of the transmitter and the data receiver aligned so that the mark and space data may be determined, the microprocessor 56 may now interpret the energy in the MSK signal as either a “0” or a “1” (mark or space). The data receiver is the combination of the receiver 46 and the signal processor 48. The collection of the mark and space information continues for the remainder of the reception of the PREAMBLE 12. At the conclusion of the PREAMBLE 12 a group of bits are transmitted as a FLAG, which may be, for example, a sequence such as “00001111”. Such a sequence can be recognized by the microprocessor 56 as being different from the bit pattern in the PREAMBLE 12, and signifies that the following data is the one or more MESSAGE 26. The recognition of the FLAG pattern thus permits synchronization of the signal processor 48 with the FRAME of the packet. Providing that the receiver clock and the transmitter clock have a small relative error, the bit synchronization and the frame synchronization may be maintained for a period of time.

Having achieved bit synchronization and frame synchronization, the receiver 46 receives, and the microprocessor 48 processes and interprets, a sequence of demodulated bits as a message. So long as both the BSC and the data receiver or mobile 44 are programmed to act in accordance with a common data protocol, the information transmitted by the BSC will be received and acted upon by the data receiver or mobile unit 44.

In the situation where the data received and processed during the 5 ms data collection period 14 does not meet the established criteria for the presence of an MSK signal, the signal processor 48 and the receiver 46 are deactivated until the expiration of an interval of 35 ms from the previous activation, when the activation 10 again occurs, the data collection period 14 collects data received by the receiver 46 and the determination of modulated signal presence performed. With a timing interval of 35 ms between activations of the receiver 46, and the overall length of the PREAMBLE 12 of 40 ms, sufficient data will be received in this second activation of the receiver 46 to make a decision as to the presence or absence of a desired signal.

In FIG. 4, illustrating the situation where a positive indication of signal presence was not obtained even though the data collection period 14 overlaps a portion of the PREAMBLE 12, the periodic activation of the receiver 46 continues, and the next data collection period 14 would be expected to have a more substantial overlap with the PREAMBLE 12, and may be sufficient for a determination that MSK data is present, and for identification of the PREAMBLE 12, so that the bit synchronization can be performed, and the FLAG scanned for and detected so as to achieve frame synchronization. Once frame synchronization has been achieved, the receiver 46 continues to be in an active state in order to receive and demodulate the data being transmitted in the frames from the BSC. At the conclusion of BSC transmission the receiver 46 and the signal processor 48 may be disabled until the next appropriate activation time, either on the basis of a pre-established time out or by sensing an end-of-transmission data pattern. In this example, the end-of-transmission data pattern 24 may be a series of eight “0” data values, although this may be omitted.

The cross-correlation process may be performed on a single sequence of data representing contiguous bits, using a sliding window of a fixed size, or using all of the data obtained up until a decision threshold is reached, extending into the time period subsequent to the initial 5 ms data collection period. Alternatively, another means of determining that a MSK signal may be used in evaluating the presence of signal energy and the cross-correlation process used to confirm the presence of the signal energy and achieve bit sync. The transition from the PREAMBLE 12 to the FLAG 20 indicates the beginning of the MESSAGE 26 is to follow, and enables frame synchronization.

When bit and frame synchronization have been achieved, the microprocessor 56 interprets the received data as a bit stream or mark and space values and decodes the message contained therein, determining whether the MESSAGE 26 is intended for the particular mobile unit 44. When a MESSAGE 26 intended for the particular mobile unit 44 has been decoded, the mobile unit 44 performs whatever action may be required to satisfy the MESSAGE 26. Messages intended for other receivers may be discarded.

The receiver clock time and the transmitter clock time have been aligned in the synchronization process, so that the process of repetitively activating the receiver may be modified so that subsequent activations are performed at times where transmissions are expected, as would obtain if the clocks were accurate and had essentially no relative drift. That is, the period between activations may be set to be equal to the time between transmissions for a BSC, for or the time between transmissions of sequential transmissions of more than one BSC in a group of BSC. This may further reduce the power consumption.

After some period of time, as a consequence of clock inaccuracy, or due to the geographical displacement of the mobile unit 44, a transmission from a BSC may no longer be received when the transmission was expected. As such, no signal may be received when the receiver is again activated, or the frame synchronization may have deteriorated to the extent that the activation 10 of the receiver occurs at a portion of the transmission not including the PREAMBLE 12. In such a situation, the mobile unit 44 may again initiate the protocol where the receiver 46 is activated periodically with a short periodic interval to detect the presence of the BSC transmissions and perform the bit synchronization and the frame synchronization.

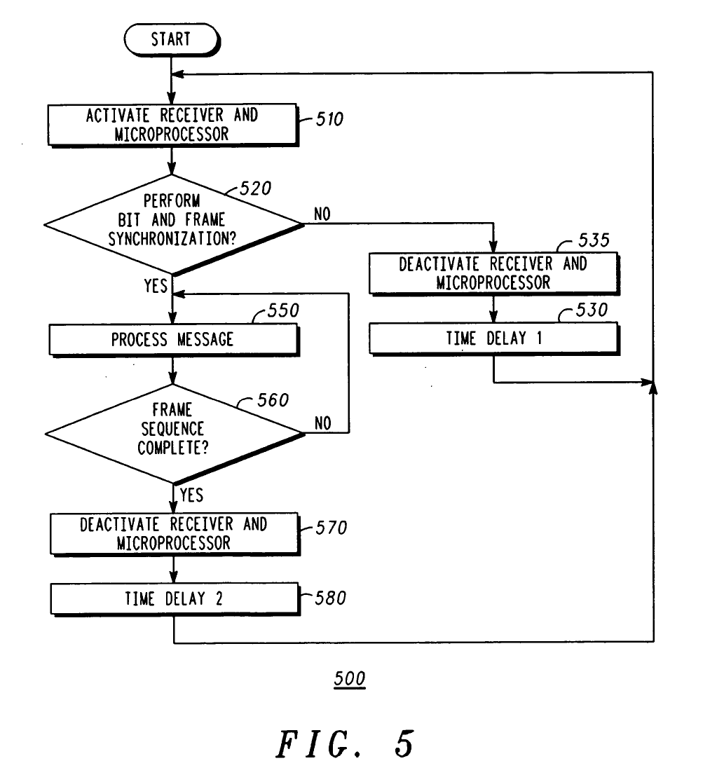

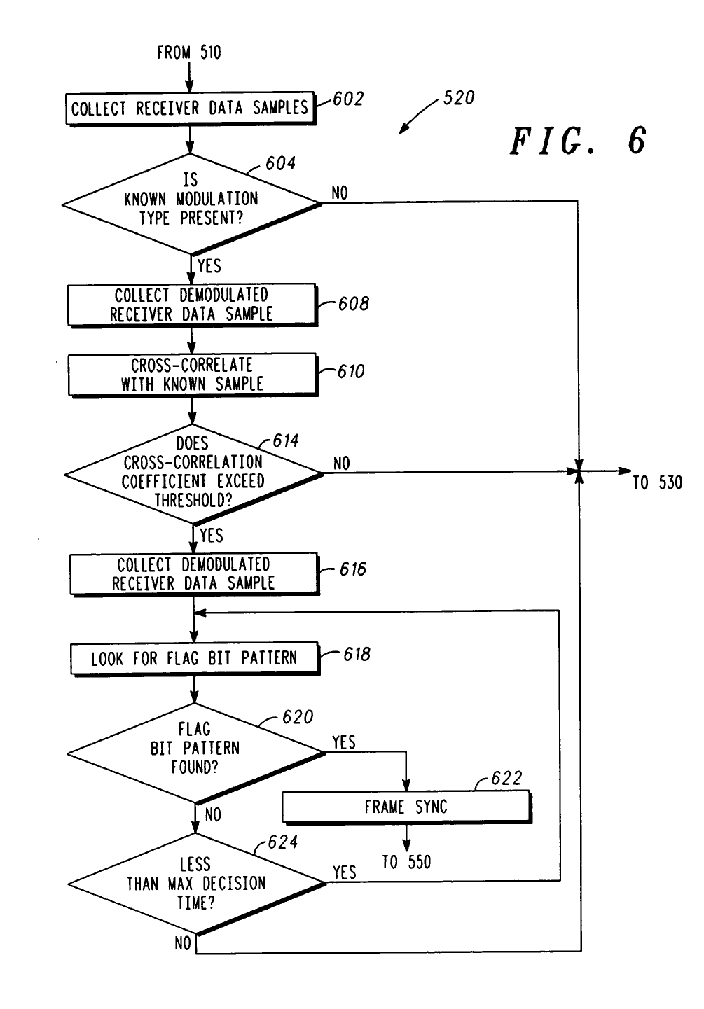

FIG. 5 and FIG. 6 illustrate an example of a method of receiving data from the BSC. In the embodiment, the method includes the steps of starting the process 500, activating the receiver and the signal processor 510, and performing analysis of the receiver data to: (a) determine whether a desired modulation is present; (b) identify the message PREAMBLE and perform bit synchronization; and, (c) perform frame synchronization 520. The details of step 520 will be further described later with respect to FIG. 6. The results of step 520 are tested to determine if a received signal has an appropriate modulation format, and that the data received has resulted in bit and frame synchronization. The completion of bit and frame synchronization is also tested in step 520, and if such synchronization is not achieved, the receiver and signal processor are disabled in step 530 and, after a delay in step 535, the receiver and signal processor are again activated in step 510.

If the test in step 520 indicates that bit and frame synchronization has been achieved, the demodulated receiver output is processed in step 550 to recover and analyze the message. As the transmitted signal may be comprised of a number of concatenated frames, any one of which may contain a message for the particular mobile receiver, step 560 determines if a predetermined number of packets have been received, a known time has elapsed or a termination bit pattern has been identified. If none of these events has occurred, the message processing of step 550 is continued. Once step 560 determines that the frame sequence is complete or that a desired message has been received, the receiver is deactivated in step 570, and step 580 provides a time delay, which may either be the same time delay as in step 535, or a different time delay. When the time delays of steps 535 and 580 differ, the time delay in step 580 may be used, for example, to maintain the receiver in a disabled state until the start of a subsequent transmission time frame for a specific BSC, and to maintain the bit and frame synchronization, to the extent this is compatible with the mobile receiver clock accuracy.

FIG. 6 illustrates details of step 520 for performing modulation analysis, and bit and frame synchronization. The output of the activated receiver is data representative of either a signal with no modulation or demodulated data, and a time interval of data is collected in step 602; in this instance, a 5 ms duration. It is known in the art that received signals containing information (or data) may be demodulated by analog or digital circuits, and that this demodulation is a function which may be performed in the receiver or the signal processor, or portions of the process allocated the receiver or signal processor. The conversion of the information transmitted by the BSC into a sequence of digital “0” and “1” states may be broadly called demodulation. When evaluating the presence of a modulation type, the signal may be analyzed prior to or subsequent to demodulation. If the desired modulation type is not found in the data sample in step 604, a logical NO is output from the process to the main process step 530. Providing that a known modulation type is found in step 604, additional receiver demodulated data is collected in step 608, which may include data from step 602 if such data was in demodulated form. The data collected in step 608 is cross-correlated with a known data sequence in step 610, the known data sequence being that which is expected to be sent as a PREAMBLE by the BSC. Step 610 may be performed in special purpose hardware, or in the memory and computational unit of the microprocessor, and may any known method of estimating a cross-correlation coefficient. The computational method chosen may be a trade-off between accuracy and complexity.

The results of step 610 are evaluated in step 614, and a logical NO output to the main process step 530 if the cross-correlation coefficient does not exceed a threshold. It should be understood that, due to differences between the transmitter and the receiver clock frequencies, the synchronization of the bit time at the output of the receiver and a corresponding time interval in the context of the signal processor may have a temporal offset corresponding to a fractional bit interval. An adjustment is made so that a received bit is substantially contained in a contiguous group of samples identified as a bit interval in the signal processor. The adjustment may consist of adjusting the local clock time, frequency or phase, or by adjusting the allocation of data to memory locations, or the like. Since the time bases at the transmitter and the receiver may be substantially identical, the synchronization of the bits thus achieved is valid for at least the duration of the transmission of a series of packets constituting the frames transmitted by the transmitter during a single time allocation. Providing that the clocks are accurate, synchronization at the bit level may be maintained for some time. As the duration of the PREAMBLE includes a number of bits (48 in this example), the re-activation of a receiver during a PREAMBLE may remain valid for a longer period of time.

Providing that the test of step 614 indicates that a cross-correlation coefficient threshold has been exceeded, data continues to be collected in step 616 and a continuous group of data bits are evaluated in step 618 to determine if a FLAG bit pattern is encountered. In this example, the pattern is “00001111”. When a running cross-correlation is being computed, the bit pattern being used may also include the FLAG bit pattern, thus reducing the portion of the PREAMBLE which must be received in order to perform the synchronization and recognition functions.

If the FLAG pattern is not encountered, the test of 620 returns to step 618 through step 624. Step 624 determines if the time elapsed since a prior event, such as the completion of step 614, is less than a known value. The time value in step 624 may be set to account for the situation where the receiver activation time is at a variable offset from the FLAG data portion due to clock inaccuracy.

When step 620 results in a determination that the FLAG pattern has been received, the process proceeds to step 622, else the output of step 620 continues to pass through step 624 until preset time value is exceeded and step 624 outputs a logical NO to the main process step 530.

When the process proceeds to step 622, the FLAG pattern is considered to indicate that one or more MESSAGE data portions follows, and the process transfers to step 550 of FIG. 5. The data bits output from the receiver are analyzed by the microprocessor in accordance with a data protocol until step 560 determines that the sequence of frames transmitted by the BSC is compete, at which time step 570 disables the receiver and signal processor. Where the term “disables” is used, it should be understood that some circuitry may remain enabled to perform timing functions such that receiver can be re-activated at a later time in an autonomous manner. Another term which might be used to describe the situation is a “power-saving mode of operation”.

The output of step 510 leads to step 580 which is a time delay having at least one of a number of purposes, for which different time delays may be provided. The delay may be equal to the time between transmissions of each of multiple BSC in a group, or the time delay associated with the period between transmissions of a particular BSC in a group, or no delay such that the re-activation occurs promptly.

Where any of the steps of the synchronization process in step 520 have failed to occur, the NO output path will have been traversed and the time delay of step 535 encountered. Typically this is a short delay, 35 ms in the example, so that the bit and frame synchronization may be repeated until the process is successful. Alternatively this time delay may be used to achieve a back-off strategy where the time interval between activations is increased in accordance with an algorithm based on the number of failures, such that the larger the number of successive failures, the longer the interval between reactivations, up to some predetermined time limit. Such an upper limit may be maintained, or the process started again.

Although the present invention has been explained by way of the examples described above, it should be understood to the ordinary skilled person in the art that the invention is not limited to the examples, but rather that various changes or modifications thereof are possible without departing from the spirit of the invention. Accordingly, the scope of the invention shall be determined only by the appended claims and their equivalents.

What is claimed is:

1. A data receiver, comprising:
a receiver, the receiver being activated at a periodic interval; and
a signal processor, configured for determining a presence of a signal with a known signal modulation type, for determining a presence of a first reference pattern, and for determining a presence of a second reference pattern.

2. The data receiver according to claim 1, wherein the signal processor includes a microprocessor, a data and program memory, and machine readable code.

3. The data receiver according to claim 1, wherein the presence of a modulated signal is determined by one of a measurement of spectral characteristics of a receiver output signal by the method of zero crossings or a cross-correlation with a signal modulation type.

4. The data receiver according to claim 1, wherein the signal processor further comprises a cross-correlator having discrete shift registers.

5. The data receiver according to claim 3, wherein the presence of a modulated signal is determined in the signal processor.

6. The data receiver according to claim 1, wherein the presence of the first reference pattern is determined by comparing a maximum of a cross-correlation coefficient with a threshold value.

7. The data receiver according to claim 1 wherein the known signal modulation type is a minimum shift keyed (MSK) signal.

8. The data receiver according to claim 6, wherein a time reference of the data receiver is adjusted such that a maximum value of the cross-correlation coefficient occurs at a zero lag value.

9. The data receiver according to claim 6, wherein the cross-correlation is performed in a first time window having a fixed duration.

10. The data receiver according to claim 6, wherein the cross-correlation is performed in a sliding time window.

11. The data receiver according to claim 1, wherein a frame sync time is determined as an end of the second reference pattern.

12. The data receiver according to claim 5, wherein the receiver and the signal processor are deactivated unless the known signal modulation type is detected.

13. The data receiver according to claim 6, wherein the receiver and the signal processor are deactivated unless the maximum cross-correlation coefficient exceeds the threshold value.

14. The data receiver according to claim 1, wherein the signal processor and the receiver are deactivated after a first known time and the periodic activation resumed after a second known time.

15. A method of receiving a signal, the method comprising:
periodically enabling a receiver;
determining that a known modulated signal is present;
demodulating the received signal;
determining whether a first known data pattern is present; and
determining whether a second known data pattern is present.

16. The method of claim 15, wherein determining of the presence of a first known data pattern includes the step of comparing a cross-correlation coefficient of the demodulated signal with a threshold.

17. The method of claim 15, further comprising adjusting a reference clock such that a maximum value of the cross-correlation coefficient occurs at a zero lag value.

18. The method according to claim 15, wherein the demodulated output following the second known data pattern is interpreted as a message.

19. The method according to claim 15, wherein the steps of determining whether a first known data pattern is received, and determining whether a second known pattern is received are performed as a combined step.
